(19) United States
(12) Patent Application Publication
(10) Pub. No.: US 2026/0109214 A1
(43) Pub. Date: Apr. 23, 2026

(54) AUXILIARY DRIVING APPARATUS OF A 4WD ELECTRIC VEHICLE

(71) Applicants: HYUNDAI MOTOR COMPANY, Seoul (KR); KIA CORPORATION, Seoul (KR)

(72) Inventors: Jongyun Park, Hwaseong-si (KR); Baekyu Kim, Hwaseong-si (KR); Chulmin Ahn, Hwaseong-si (KR); Sung Gon Byun, Hwaseong-si (KR); Won Seok Lee, Hwaseong-si (KR); Junyoung Ha, Hwaseong-si (KR); Su Hyeon Maeng, Hwaseong-si (KR); Dong Hui Cheon, Hwaseong-si (KR); Jieun Kim, Hwaseong-si (KR); Yohan Kim, Hwaseong-si (KR); Jaehyuk Seo, Hwaseong-si (KR); Jongho Jung, Hwaseong-si (KR); Yunkyung Ji, Hwaseong-si (KR); Sun Sung Kwon, Hwaseong-si (KR); Chonok Kim, Hwaseong-si (KR)

(73) Assignees: HYUNDAI MOTOR COMPANY, Seoul (KR); KIA CORPORATION, Seoul (KR)

(21) Appl. No.: 19/361,670

(22) Filed: Oct. 17, 2025

(30) Foreign Application Priority Data
Oct. 21, 2024 (KR) 10-2024-0143684

(51) Int. Cl. B60K 6/52; B60K 6/24; B60K 6/26; B60K 6/387

(52) U.S. Cl. CPC B60K 6/52; B60K 6/24; B60K 6/26; B60K 6/387

(57) ABSTRACT

An auxiliary driving apparatus for a 4WD hybrid electric vehicle includes a disconnector between an auxiliary differential and a front wheel and configured to selectively transmit or block a motor torque to front wheels of the hybrid electric vehicle. The hybrid electric vehicle includes a first motor configured to be applied to a rear wheel side as a main driving source, and an engine and an auxiliary motor configured to be applied as an auxiliary driving source. A rotation speed of the motor torque output from the auxiliary motor is reduced by an auxiliary reducer and transmitted to front wheels through an auxiliary differential. A clutch provided on an engine output shaft is configured to selectively transmit or block an engine torque of the engine to the auxiliary motor through the auxiliary reducer. The auxiliary reducer is configured to increase a rotation speed of the engine torque of the engine.

### CROSS-REFERENCE TO RELATED APPLICATION

This application claims the benefit of and priority to Korean Patent Application No. 10-2024-0143684, filed with the Korean Intellectual Property Office on Oct. 21, 2024, the entire contents of which are hereby incorporated herein by reference.

### BACKGROUND

### (a) Technical Field

The present disclosure relates to an auxiliary driving apparatus of a 4WD hybrid electric vehicle, and more particularly, relates to an auxiliary driving apparatus applied to a front wheel side of a hybrid electric vehicle, where a motor is applied to a rear wheel side as a main driving source, in a series type.

### (b) Description of the Related Art

Environment-friendly technology in the vehicle field is a core technology that may determine the survival of the future vehicle industry, and vehicle manufacturers are making all-out efforts to develop environment-friendly vehicles to meet environmental and fuel efficiency regulations.

As part of environment-friendly vehicle, vehicle manufacturers are focusing on developing environment-friendly electric vehicles such as hybrid electric vehicle (HEV), plug-in hybrid electric vehicle (PHEV), pure electric vehicle (BEV: Battery Electric Vehicle), and fuel cell electric vehicle (FCEV).

Because environment-friendly vehicles have various technical constraints such as weight and cost, vehicle manufacturers are paying attention to electric vehicles as a realistic alternative to satisfy exhaust gas regulations and improve fuel efficiency performance, and are competing in research and development of power delivery devices to put electric vehicles into practice.

An environment-friendly vehicle provides torque using a motor as a power source, and then increases the torque through a reducer to provide driving torque to the vehicle, which can contribute to improving air pollution caused by existing pure internal combustion engine vehicles.

In the case of four-wheel drive (4WD) hybrid electric vehicles, the drive system is divided into in parallel type, power branch type, and series type. The parallel type is a system that adds a motor to a vehicle to which an existing gasoline engine is applied to minimize the torque and output of the motor. The engine power is directly transmitted to the drive shaft, and the motor power assists.

Additionally, the power branch type is a system that converts part of the engine power into two large motors and a planetary gear set and transmits it to the drive shaft.

FIG. 8 is a schematic view of the drive system of a typical serial type 4WD hybrid electric vehicle.

Referring to FIG. 8, the series type is a system optimized for the series mode that converts all power generated from an engine ENG into electricity through a second motor MG2, which is an auxiliary drive source for the front wheels, and then converts it into power through a first motor MG1, which is the main drive source for the rear wheels, to drive the vehicle.

In a hybrid electric vehicle of the serial type, the auxiliary driving apparatus applied to the front wheel side includes a disconnector system, and when driving in 2WD, the vehicle body and the auxiliary driving apparatus (motor and reducer, etc.) are separated to reduce the drag torque due to the electric power of the motor or the drag torque of the reducer, and a technology is applied to improve the fuel efficiency.

Accordingly, a series-type hybrid electric vehicle may implement a rear wheel 2WD driving EV mode by operating the disconnector applied to the auxiliary driving apparatus on the front wheel side in the series mode and disengaging it.

However, in order to implement 4WD (or all-wheel drive (AWD)) driving, the disconnector must be maintained in an operating state, so the engine ENG cannot be separated from the drive system (reducer, etc.). In particular, in 4WD driving EV mode where the engine ENG is stopped, there is a problem that the power efficiency is adversely affected due to the stationary load transferred from the engine ENG to the drivetrain (reduction gear, etc.).

The information contained in this background section is intended to enhance understanding of the background of the present disclosure and may include matters that are not conventional art already known to a person of ordinary skill in the art to which the present disclosure pertains.

### SUMMARY

Aspects of the present disclosure provide an auxiliary driving apparatus of a serial type that may be applied as a driving mechanism, of a hybrid electric vehicle including an engine, a motor, a clutch, and a disconnector, to the front wheel side of the hybrid electric vehicle with a motor applied to the rear wheel side as the main driving source of the hybrid electric vehicle.

In an aspect, the auxiliary driving apparatus may implement a series mode in the rear wheel two-wheel drive (2WD) mode, while enabling 4WD (or AWD) EV mode operation with the engine stopped, thereby increasing fuel efficiency.

According to an embodiment, an auxiliary driving apparatus for a front wheel side of a 4WD hybrid electric vehicle is provided. The hybrid electric vehicle may include a first motor applied to a rear wheel side as a main driving source and an engine and an auxiliary motor applied as an auxiliary driving source, where a motor torque output from the auxiliary motor is reduced in rotation speed by an auxiliary reducer and is transmitted to front wheels on two sides of the hybrid electric vehicle through an auxiliary differential configured to absorb a difference in rotation speed. The auxiliary driving apparatus includes a disconnector arranged between the auxiliary differential and one front wheel of the hybrid electric vehicle and configured to selectively transmit or block the motor torque of the auxiliary motor output through the auxiliary reducer to the two front wheels of the hybrid electric vehicle. The auxiliary driving apparatus also includes a clutch provided on an engine output shaft of the engine. The clutch is configured to selectively transmit or block an engine torque of the engine to the auxiliary motor, where a rotational speed of the engine torque is increased by the auxiliary reducer.

The disconnector may include a dog clutch arranged between a pinion shaft of the auxiliary differential and a differential case.

The disconnector may include a dog clutch provided on a front wheel drive shaft among front wheel drive shafts that transmit torque from the auxiliary differential to the front wheels on the two sides of the hybrid electric vehicle.

The clutch may comprise a dog clutch or a wet-type clutch.

The auxiliary reducer may include a first input gear fixed to a motor shaft of the auxiliary motor, a second input gear rotatably installed on the engine output shaft and selectively connected to the engine output shaft via the clutch, an idle shaft arranged parallel between the engine output shaft and the auxiliary differential, and first and second idle gears fixedly installed on a first side and a second side of the idle shaft and externally engaged with the second input gear and the differential ring gear of the auxiliary differential, respectively.

Gear ratios of the first and second input gears may be set to reduce rotation speed of the motor torque of the auxiliary motor.

Gear ratios of the first and second idle gears may be set to reduce rotation speed of the motor torque input from the second input gear and transmit the motor torque to the differential ring gear.

In 2WD EV mode, the disconnector may be disengaged and a power delivery path through which the motor torque of the auxiliary motor is transmitted to a front wheel drive shaft may be blocked. In 2WD series mode, the disconnector may be disengaged and the clutch may be operated so that a power delivery path through which the engine torque of the engine is transmitted to the auxiliary motor may be connected.

In 4WD (or AWD) EV mode, the disconnector may be operated and the clutch may be released, and a power delivery path that transmits the motor torque of the auxiliary motor to a front wheel drive shaft may be connected.

According to another embodiment, an auxiliary driving apparatus for a 4WD hybrid electric vehicle is provided. The electric vehicle includes a first motor applied to a rear wheel side as a main driving source. The auxiliary driving apparatus includes an auxiliary motor provided on a front wheel side and configured to output a motor torque. The auxiliary driving apparatus also includes an engine provided on the front wheel side and configured to provide an engine torque to the auxiliary motor. The auxiliary driving apparatus additionally includes an auxiliary differential disposed between front wheel drive shafts on two sides of the hybrid electric vehicle and configured to absorb a difference in rotation speed of front wheels on the two sides of the hybrid electric vehicle and transmit the motor torque of the auxiliary motor to front wheel drive shafts on the two sides of the hybrid electric vehicle. The auxiliary driving apparatus further includes an auxiliary reducer configured to reduce rotation speed of the motor torque input from the auxiliary motor through first and second idle gears on an idle shaft arranged parallel between an engine output shaft of the engine and the auxiliary differential and output the motor torque to a differential ring gear of the auxiliary differential. The auxiliary driving apparatus also includes a disconnector disposed between the auxiliary differential and a front wheel among the front wheels of the electric hybrid vehicle and configured to selectively transmit or block the motor torque of the auxiliary motor output through the auxiliary reducer to the front wheels on the two sides of the hybrid electric vehicle. The auxiliary driving apparatus additionally includes a clutch provided on the engine output shaft of the engine and configured to selectively transmit or block an engine torque of the engine to the auxiliary motor, where a rotation speed of the engine torque of the engine is increased by the auxiliary reducer.

The auxiliary driving apparatus according to embodiments of the present disclosure may be applied as a driving mechanism of a 4WD hybrid electric vehicle that includes an engine and a second motor, where the auxiliary driving apparatus includes a second reducer, a clutch, and a disconnector provided on the front wheel side of the hybrid electric vehicle, and where the hybrid electric vehicle also includes a first motor applied to the rear wheel side as a main driving source of the hybrid electric vehicle. With the disconnector in operation, the power generated from the engine may be converted to electricity and used through the second motor, which is the auxiliary drive source on the front wheel side, without being affected by the drag torque generated from the second motor or the second reducer. The auxiliary driving apparatus thus enables the implementation of a series mode of a series-type hybrid electric vehicle in which the generated electrical energy is converted into power through the first motor, which is the main driving source on the rear wheel side, to drive the vehicle. In addition, by operating the clutch, it is possible to increase power efficiency by enabling 4WD (or AWD) EV mode driving while the engine is stopped.

In addition, other effects that may be obtained or expected according to embodiments of the present disclosure are directly or implicitly disclosed in the detailed description that follows.

### BRIEF DESCRIPTION OF THE DRAWINGS

Because the drawings are provided for reference to describe embodiments of the present disclosure, the technical ideas of the present disclosure should not be interpreted as limited to the attached drawings.

FIG. 1 is a schematic diagram of an auxiliary driving apparatus of a 4WD hybrid electric vehicle according to an embodiment of the present disclosure.

FIG. 2 is an operation table of driving methods of an auxiliary driving apparatus of a 4WD hybrid electric vehicle according to an embodiment of the present disclosure.

FIGS. 3 and 4 are operation state diagrams of an auxiliary driving apparatus of a 4WD hybrid electric vehicle in the 2WD series mode and the 4WD EV mode according to an embodiment of the present disclosure.

FIG. 5 is a schematic diagram of an auxiliary driving apparatus of a 4WD hybrid electric vehicle according to another embodiment of the present disclosure.

FIG. 6 is a schematic diagram of an auxiliary driving apparatus of a 4WD hybrid electric vehicle according to yet another embodiment of the present disclosure.

FIG. 7 is a schematic diagram of an auxiliary driving apparatus of a 4WD hybrid electric vehicle according to still another embodiment of the present disclosure.

FIG. 8 is a schematic view of the drive system of a typical serial type 4WD hybrid electric vehicle.

The drawings referenced above are not necessarily to scale, but should be understood as presenting rather simplified representations of various features illustrating the basic principles of the present disclosure. For example, certain design features of the present disclosure, including particular dimensions, direction, position, and shape, will be determined in part by the particular intended application and usage environment.

### DETAILED DESCRIPTION

Hereinafter, embodiments of the present disclosure are described in detail with reference to the accompanying drawings. It should be noted that identical or similar components are designated by the same or similar reference numerals and redundant descriptions thereof have been omitted.

It the following description, where it was determined that a detailed description of related known technology would obscure the gist of the present disclosure, the detailed description thereof has been omitted. In addition, the accompanying drawings are merely intended to facilitate understanding of the embodiments described in this specification, and the technical ideas disclosed in this specification are not limited by the accompanying drawings. Rather, the present disclosure should be understood to include all modifications, equivalents, or substitutes included in the spirit and technical scope of the present disclosure.

Terms that include ordinal numbers, such as first, second, etc., may be used to describe various configurations of elements, but the components are not limited by the terms. The terms are used solely to distinguish one component from another.

When a component is said to be “connected to” or “combined with” another component, it should be understood that the component may be directly connected to or combined with the other component, but there may also be one or more other components therebetween. On the other hand, when a component is said to be “directly connected to” or “directly combined with” another component, it should be understood that there are no other components in between.

In the present specification, it should be understood that terms such as “include”, “have”, “comprise, or the like, are intended to specify the presence of a feature, number, step, operation, component, part or combination thereof described in the specification, but do not exclude the possibility of the presence or addition of one or more other features, numbers, steps, operations, components, parts or combinations thereof.

Terms such as “unit”, “portion”, “part”, “module”, and “means” described in the specification are assigned or used interchangeably only for the convenience of writing the specification, and do not have distinct meanings or roles in themselves. Terms such as “unit”, “portion”, “part”, “module”, and “means” described in the specification may mean a unit that processes at least one function or operation, and this may be implemented by hardware, software, or a combination of hardware and software.

As used herein, the singular forms are intended to include the plural forms as well, unless the context clearly indicates otherwise. As used herein, the term “and/or”includes any one or all combinations of the associated listed items.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

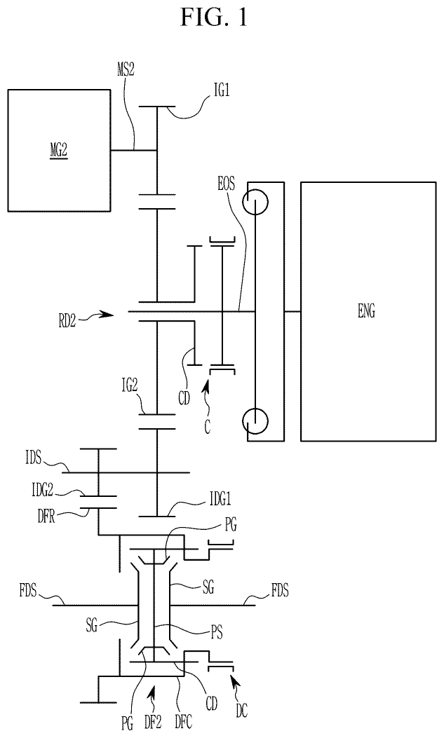

Hereinafter, embodiments of the present disclosure are described in more detail with reference to FIGS. 1-8.

For reference, symbols in FIG. 1-8 are as follows.

### DESCRIPTION OF SYMBOLS

10: rear wheel side driving apparatus (main driving apparatus)
20: front wheel side driving apparatus (auxiliary driving apparatus)
ENG: engine
EOS: engine output shaft
MG1, MG2: first, second motor
RD1, RD2: first, second reducer
FW: front wheel
RW: rear wheel
FDS: front wheel drive shaft
RDS: rear wheel drive shaft
DC: disconnector
C: clutch
CD: clutch dog
IG1, IG2; first, second input gear
IDS: idle shaft
IDG1, IDG2: first, second idle gear
DF1, DF2: first, second differential
DFR: differential ring gear
DFC: differential case
PS: pinion shaft
PG: pinion gear
SG: side gear
BT: battery

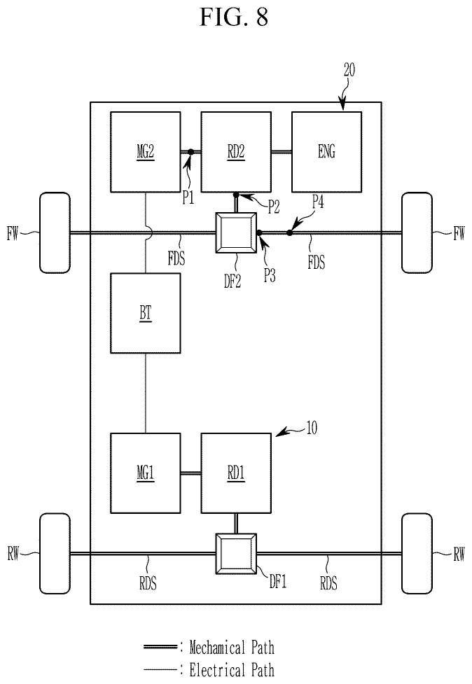

FIG. 8 is a schematic view of a drive system of a typical serial type 4WD hybrid electric vehicle.

Referring to FIG. 8, a drive system of a typical 4WD hybrid electric vehicle includes a rear wheel-side driving apparatus 10 (i.e., a main driving apparatus) including a first motor MG1, a first reducer RD1, and a first differential DF1 provided on a rear wheel RW side and transmitting power to the left and right rear wheels RW through left and right rear wheel drive shafts RDS. The 4WD hybrid electric vehicle also includes a front wheel-side driving apparatus 20 (i.e., an auxiliary driving apparatus) including an engine ENG, a second motor MG2, a second reducer RD2, and a second differential DF2 provided on a front wheel FW side and transmitting power to the left and right front wheels FW through left and right front wheel drive shafts FDS. The 4WD hybrid electric vehicle additionally includes a battery BT supplying power to the first and second motors MG1 and MG2.

The first and second motors MG1, MG2 generate output torque by controlling the rotating direction and rotation speed (RPM) under control of the MCU (Motor Control Unit). The first motor MG1 provides power to the left and right rear wheels RW, and the second motor MG2 provides power to the left and right front wheels FW.

These first and second motors MG1 and MG2 may also be used as generators to charge battery BT by generating counter electric power when the battery's state of charge (SOC) is low or during regenerative braking.

The first and second reducers RD1, RD2 are a type of transmission that reduces rotation speed and transmits the power generated from the first and second motors MG1, MG2 to the corresponding wheels RW FW, respectively. The first reducer RD1 controls the rotation speed (motor torque) of the first motor MG1 and transmits the motor torque to the left and right rear wheels RW. The second reducer RD2 controls the rotation speed (motor torque) of the second motor MG2 and transmits the motor torque to the left and right front wheels FW.

The first and second differentials DF1, DF2 are connected to the first and second reducers RD1, RD2, respectively, and transmit the output torque of the first and second reducers RD1, RD2 to the corresponding wheels RW and FW. The first reducer RD1 transmits the power generated from the first motor MG1 while absorbing the difference in rotation speed between the left and right rear wheels RW. The second reducer RD2 transmits the power generated from the second motor MG2 while absorbing the difference in rotation speed between the left and right front wheels FW.

The drive system of a 4WD hybrid battery vehicle having such a configuration operates the rear wheel side as the main drive wheel and the front wheel side as the auxiliary drive wheel, so that when driving in 4WD (or AWD), both the rear wheel side driving apparatus 10 and the front wheel side driving apparatus 20 are driven to transmit power to the rear wheel RW and the front wheel FW, respectively. On the other hand, when driving in 2WD, only the rear wheel side driving apparatus 10 is driven to transmit power to the rear wheel RW, and power is cut off to the front wheel FW.

The driving system of a typical 4WD hybrid electric vehicle illustrated in FIG. 8 is described as a reference for understanding the auxiliary driving apparatus of a 4WD hybrid electric vehicle according to embodiments of the present disclosure.

As used herein, the term “4WD” hybrid electric vehicle may refer to any hybrid electric vehicle having four or more wheels, provided that at least two wheels at the front and at least two wheels at the rear are driven, and includes systems that may also be referred to as all-wheel drive (AWD).

In explaining the auxiliary driving apparatus of a 4WD hybrid electric vehicle according to embodiments of the present disclosure, a repeated explanation of the same configuration as the driving system of the 4WD hybrid electric vehicle described above with reference to FIG. 8 has been omitted.

FIG. 1 is a schematic diagram of an auxiliary driving apparatus of a 4WD hybrid electric vehicle according to an embodiment of the present disclosure. Referring to FIG. 1, a front wheel side driving apparatus 20 (sometimes referred to herein as an auxiliary driving apparatus 20) of a 4WD hybrid electric vehicle according to an embodiment of the present disclosure includes a disconnector DC configured to cut off power of a second motor MG2 to the front wheel FW.

Referring to FIG. 8, in various embodiments, the disconnector DC may be installed at one side P1 of a second motor shaft MS2 to which the power of the second motor MG2 is directly transmitted, or at one side P2 of the second reducer RD2, or at one side P3 of the second differential DF2, or at one side P4 of the front wheel drive shaft FDS. The disconnector DC may be installed in any one or more of the four locations P1, P2, P3, and P4 of the driving apparatus 20 on the front wheel side of the auxiliary driving wheel, and there are differences in power consumption, engage impact, engage time, etc. depending on the installation position.

Depending on the installation position, the P1 and P2 positions may be advantageous in terms of engage impact or engage time, but may be disadvantageous in terms of power efficiency. On the other hand, the P3 and P4 positions may be advantageous in terms of power efficiency, but may be disadvantageous in terms of engage impact or engage time.

In an embodiment of present disclosure, as an example, in the auxiliary driving apparatus 20 of a 4WD hybrid electric vehicle, a disconnector DC is installed on one side P3 of the second differential DF2 of the driving apparatus 20 on the front wheel side with the auxiliary driving wheel on the front wheel FW side.

Hereinafter, the auxiliary driving apparatus 20 of a 4WD hybrid electric vehicle, according to embodiments of the present disclosure, is described with reference to examples in which the auxiliary driving wheel is the front wheel FW, and some components not shown in FIG. 8 are expressed without distinguishing between the front wheel FW side and the rear wheel RW side. Accordingly, the components may be expressed simply as differential case DFC, differential ring gear DFR, pinion shaft PS, pinion gear PG, side gear SG, etc.

The auxiliary driving apparatus 20 includes a second motor MG2, an engine ENG, a second differential DF2, a second reducer RD2, a disconnector DC, and a clutch C.

In explaining the auxiliary driving apparatus 20 according to embodiments of the present disclosure, the second motor MG2, the second differential DF2, and the second reducer RD2 on the auxiliary driving wheel side are explained separately from the first motor MG1, the first reducer RD1, and the first differential DF1 on the driving wheel side. According to embodiments, the second motor MG2, the second differential DF2, and the second reducer RD2 may be understood as the auxiliary motor MG2, the auxiliary differential DF2, and the auxiliary reducer RD2, respectively.

The second motor MG2 may be installed on the front wheel FW side, which is the auxiliary drive wheel, and may output torque. The engine ENG may be arranged on the front wheel FW side and may provide torque to the second motor MG2.

The second differential DF2 may be arranged between front wheel drive shafts FDS on both sides of the front wheel FW. The second differential DF2 may be configured to absorb the difference in rotation speed of the front wheels FW on both sides and transmit the torque of the second motor MG2 to the front wheel drive shafts FDS on both sides.

In an embodiment, the second differential DF2 may transmit the torque input from the second reducer RD2 to a differential ring gear DFR connected to a differential case DFC through a side gear SG that revolves with a pinion gear PG on a pinion shaft PS. The torque may thus be transmitted to the front wheel drive shafts FDS on both sides to the front wheels FW of the vehicle. The second differential DF2 may perform a differential function by absorbing the difference in rotation speed of the front wheels FW on both sides by the rotation of the pinion gear PG.

The second reducer RD2 may be configured to reduce rotation speed of the torque input from the second motor MG2 through first and second idle gears IDG1, IDG2 on an idle shaft IDS which is arranged parallel between the engine output shaft EOS of the engine ENG and the second differential DF2, and to output the torque to the differential ring gear DFR of the second differential DF2.

Accordingly, the second reducer RD2 includes the first and second input gears IG1 IG2, the idle shaft IDS, and the first and second idle gears IDG1 IDG2, in an embodiment.

The first input gear IG1 may be fixed to the second motor shaft MS2 of the second motor MG2 and may rotate together with the second motor shaft MS2.

The second input gear IG2 may be configured to be rotatably installed on the engine output shaft EOS and selectively connected to the engine output shaft EOS. In an embodiment, the second input shaft IG2 is provided on the engine output shaft EOS and is rotatably installed separately from the engine output shaft EOS.

The gear ratios of the first and second input gears IG1, IG2 may be set to reduce rotation speed of the torque of the second motor MG2.

The idle shaft IDS may be arranged in parallel between the engine output shaft EOS and the second differential DF2.

The first and second idle gears IDG1, IDG2 may be fixedly installed on one side and the other side of the idle shaft IDS, respectively, and may be configured to rotate together with the idle shaft IDS. The first idle gear IDG1 may be externally engaged with the second input gear IG2, and the second idle gear IDG2 may be externally engaged with the differential ring gear DFR of the second differential DF2.

First, the gear ratios of the first and second idle gears IDG1, IDG2 may be set to reduce rotation speed of the torque input from the second input gear IG2 and the torque may then be transmitted to the differential ring gear DFR.

The disconnector DC may be arranged between the second differential DF2 and one front wheel FW. The disconnector DC may be configured to selectively transmit or block the torque of the second motor MG2 output through the second reducer RD2 to the front wheel FW on both sides of the vehicle.

The disconnector DC may include a dog clutch acting on a clutch dog CD connected to the pinion shaft PS, which is configured in the differential case DFC of the second differential DF2.

The clutch C may be provided on the engine output shaft EOS of the engine ENG, and may be configured to selectively transmit or block the torque of the engine ENG to the second motor MG2 by increasing rotation speed through the second reducer RD2.

The clutch C may include a dog clutch acting on the clutch dog CD connected to one side of the hub of the second input gear IG2 on the engine output shaft EOS.

Hereinafter, the operation of the auxiliary driving apparatus of the 4WD hybrid electric vehicle, according to embodiments of the present disclosure, is described for different driving methods and modes.

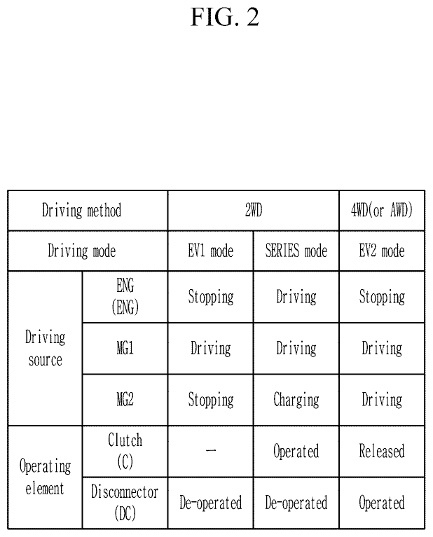

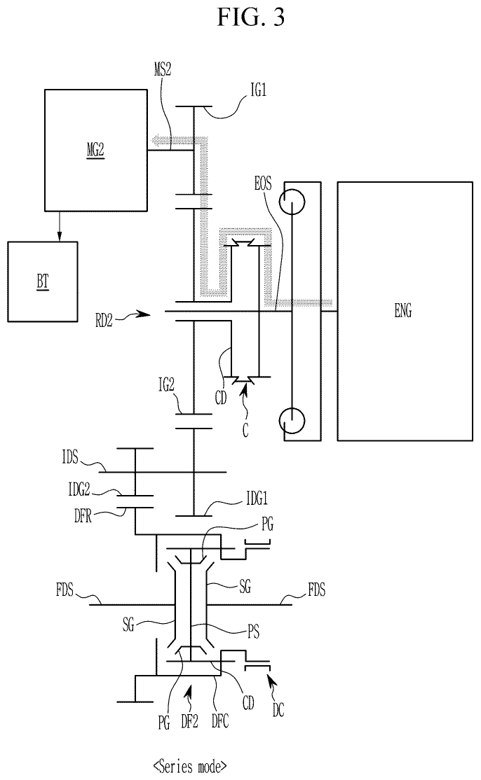

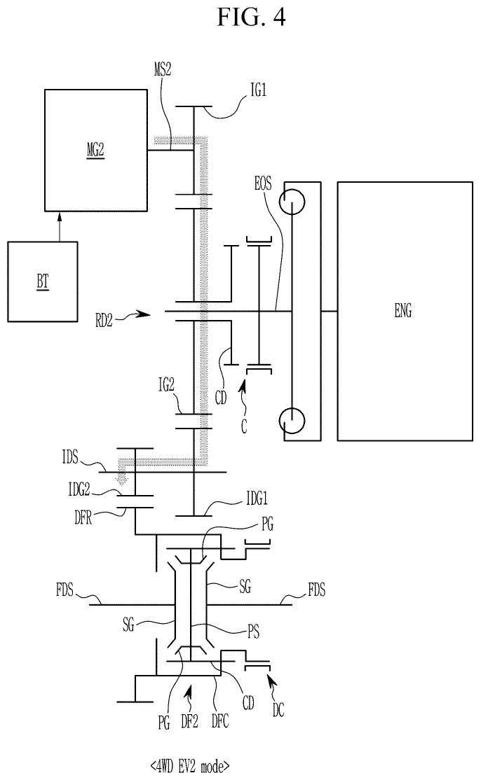

FIG. 2 is an operation table of driving methods and modes of an auxiliary driving apparatus of a 4WD hybrid electric vehicle according to an embodiment of the present disclosure. FIGS. 3 and 4 are operation state diagrams of an auxiliary driving apparatus of a 4WD hybrid electric vehicle in the 2WD series mode and the 4WD EV mode according to an embodiment of the present disclosure.

Before explaining the operation of the auxiliary driving apparatus 20 according to an embodiment of the present disclosure, it is noted that, according to an embodiment, the auxiliary driving apparatus 20 may be applied and operated on the front wheel FW side, which is an auxiliary driving wheel of a 4WD hybrid electric vehicle, and may be operating as 2WD driving or 4WD driving depending on the driving method.

The auxiliary driving apparatus 20 according to an embodiment of the present disclosure transmits the torque of the second motor MG2 to the front wheel FW side only when driving in 4WD, and when driving in 2WD, the power delivery path between the second motor MG2 and the front wheel FW is blocked by releasing the operation of the disconnector DC, thereby controlling them not to be connected.

### 2WD EV Mode EV1 Driving

Referring to FIG. 2, when driving in 2WD EV mode EV1, the engine ENG and second motor MG2 on the front wheel FW side are stopped, the disconnector DC is de-operated, and the power delivery path through which the torque of the second motor MG2 is transmitted to the front wheel drive shaft FDS is blocked.

The first motor MG1 on the rear wheel RW side drives in the 2WD EV mode EV1.

It may be advantageous for the clutch C to be remained in operation state for the sake of comparison in series mode, regardless of whether it is in operation or not.

### 2WD Series Mode Driving

Referring to FIGS. 2 and 3, in 2WD series mode, while the disconnector DC is de-operated as in the 2WD EV mode EV1, the engine ENG drives, and the clutch C operates so that the torque of the engine ENG is transmitted to the second motor MG2 on the front wheel FW side with increase rotation speed through the second reducer RD2, generating power and charging the battery BT. The first motor MG1 on the rear wheel RW side may drive in 2WD series mode using electricity from the battery BT.

### 4WD (or AWD) EV Mode EV2 Driving

Referring to FIGS. 2 and 4, when driving in 4WD (or AWD) EV mode EV2, the engine ENG on the front wheel FW side is stopped, the second motor MG2 is driven, the clutch C is released, and the disconnector DC is operated.

Then, the torque of the second motor MG2 on the front wheel FW side is transmitted to the second differential DF2 through the second reducer RD2, and driving of the 4WD EV mode EV2 is achieved together with the driving of the first motor MG1 on the rear wheel RW side.

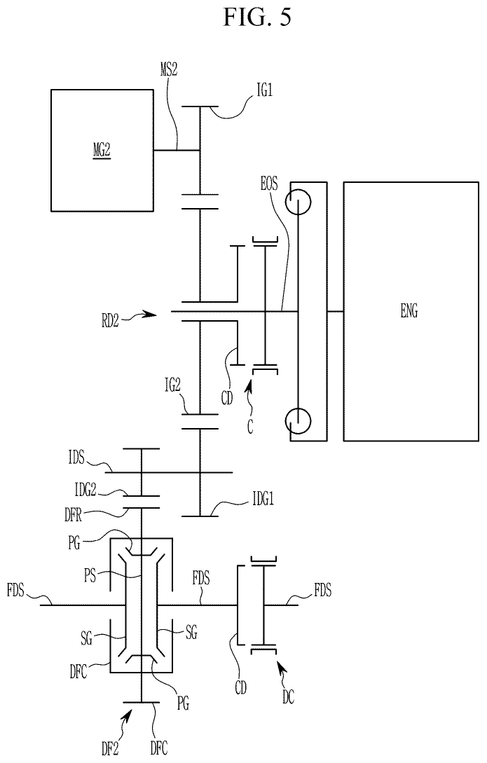

FIG. 5 is a schematic diagram of an auxiliary driving apparatus of a 4WD hybrid electric vehicle according to another embodiment of the present disclosure.

Referring to FIG. 5, In the auxiliary driving apparatus of a 4WD electric vehicle 20 according to this embodiment, there is a difference in the installation position of the disconnector DC as compared to the embodiment described above with reference to FIG. 1.

In particular, the disconnector DC according to embodiments of the present disclosure described above is configured as a dog clutch operating on the clutch dog CD connected to the pinion shaft PS and configured on the differential case DFC of the second differential DF2. However, in another embodiment of the present disclosure, the disconnector DC may include a dog clutch configured on one of the front wheel drive shafts FDS, which transmits torque from the second differential DF2 to the front wheels FW, and operating on the clutch dog CD.

Likewise, the embodiment of FIG. 5 is different from the embodiments of the present disclosure described above only in the installation position of the applied disconnector DC, and the other configurations, operations and effects are the same, so repeated explanations are omitted.

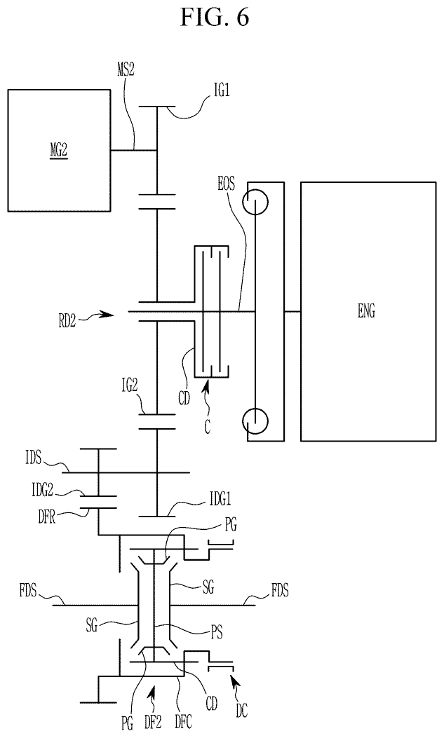

FIG. 6 is a schematic diagram of an auxiliary driving apparatus of a 4WD hybrid electric vehicle according to another embodiment of the present disclosure.

Referring to FIG. 6, in the auxiliary driving apparatus of a 4WD electric vehicle 20 according to this embodiment, there is a difference in the type of clutch C as compared to the embodiment described above with reference to FIG. 1.

In particular, the clutch C according to the embodiment described above with reference to FIG. 1 comprises the dog clutch acting on the clutch dog CD connected to one side of the hub of the second input gear IG2 on the engine output shaft EOS. On the other hand, in the embodiment of FIG. 6, the clutch C comprises a wet-type clutch applied as a clutch disk and a clutch plate between the engine output shaft EOS and the hub of the second input gear IG2 and operated by hydraulic pressure.

Likewise, the embodiment of FIG. 6 is different from the embodiment described above with reference to FIG. 1 only in the type of clutch C applied, and the other configurations, operations and effects are the same, so repeated explanations are omitted.

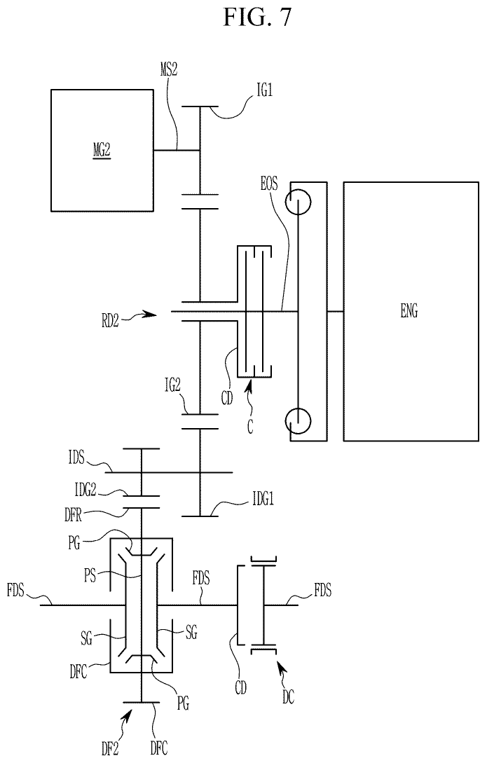

FIG. 7 is a schematic diagram of an auxiliary driving apparatus of a 4WD hybrid electric vehicle according to yet another embodiment of the present disclosure.

Referring to FIG. 7, in the auxiliary driving apparatus of a 4WD electric vehicle 20 according to this embodiment, there is a difference in the type of clutch C as compared to the embodiments described above.

In particular, the clutch C according to the embodiment illustrated in FIG. 5 comprises the dog clutch acting on the clutch dog CD connected to one side of the hub of the second input gear IG2 on the engine output shaft EOS. On the other hand, in the embodiment illustrated in FIG. 7, the clutch C comprises a wet-type clutch applied as a clutch disk and a clutch plate between the engine output shaft EOS and the hub of the second input gear IG2 and operated by hydraulic pressure.

Likewise, the embodiment of FIG. 7 is different from the embodiments described above only in the type of clutch C, and the other configurations, operations, and effects are the same, so repeated explanations are omitted.

The auxiliary driving apparatus 20 of a 4WD electric vehicle according to embodiments of the present disclosure may be applied as a driving mechanism including the engine ENG, the second motor MG2, the second reducer RD2, the clutch C, and the disconnector DC on the front wheel FW side of a series-type hybrid electric vehicle, which has the first motor MG1 applied to the rear wheel RW side as a main driving source. With the disconnector DC in operation, the power generated from the engine ENG may be converted to electricity and used through the second motor MG2, which is the auxiliary drive source on the front wheel FW side, without being affected by the drag torque generated from the second motor MG2 or the second reducer RD2. This enables the implementation of a series mode in which the generated electrical energy is converted into power through the first motor MG1, which is the main driving source on the rear wheel RW side, to drive the vehicle.

In addition, by operating the clutch C, it is possible to increase power efficiency by enabling 4WD (or AWD) EV mode EV2 driving while the engine ENG is stopped.

Although the present disclosure has been described above with reference to example embodiments thereof, it should be understood by those having ordinary skill in the art that various modifications and changes may be made to the described embodiments without departing from the spirit and scope of the present disclosure as set forth in the following claims.

What is claimed is:

1. An auxiliary driving apparatus for a front wheel side of a four-wheel drive (4WD) hybrid electric vehicle, the auxiliary driving apparatus comprising:
a disconnector disposed between an auxiliary differential and a front wheel of the hybrid electric vehicle,
wherein:
the hybrid electric vehicle includes i) a first motor configured to be applied to a rear wheel side of the hybrid electric vehicle as a main driving source and ii) an engine and an auxiliary motor configured to be applied as an auxiliary driving source, wherein a motor torque of the auxiliary motor is reduced in rotation speed by an auxiliary reducer and is transmitted to front wheels on two sides of the hybrid electric vehicle through the auxiliary differential, wherein the auxiliary differential is configured to absorb a difference in rotation speed, and
the disconnector is configured to selectively transmit or block the motor torque output through the auxiliary reducer to the front wheels on the two sides of the hybrid electric vehicle; and
a clutch provided on an engine output shaft of the engine, the clutch configured to selectively transmit or block an engine torque of the engine to the auxiliary motor through the auxiliary reducer, wherein the auxiliary reducer is configured to increase a rotation speed of the engine torque of the engine and transmit the engine torque to the auxiliary motor.

2. The auxiliary driving apparatus of claim 1, wherein the disconnector comprises a dog clutch disposed between a pinion shaft of the auxiliary differential and a differential case.

3. The auxiliary driving apparatus of claim 1, wherein the disconnector comprises a dog clutch provided on a front wheel drive shaft among front wheel drive shafts that transmit the motor torque from the auxiliary differential to the front wheels on the two sides of the hybrid electric vehicle.

4. The auxiliary driving apparatus of claim 1, wherein the clutch comprises a dog clutch or a wet-type clutch.

5. The auxiliary driving apparatus of claim 1, wherein the auxiliary reducer comprises:
a first input gear fixed to a motor shaft of the auxiliary motor;
a second input gear rotatably installed on the engine output shaft and selectively connected to the engine output shaft via the clutch;
an idle shaft arranged parallel between the engine output shaft and the auxiliary differential; and
first and second idle gears fixedly installed on a first side and a second side of the idle shaft and externally engaged with the second input gear and a differential ring gear of the auxiliary differential, respectively.

6. The auxiliary driving apparatus of claim 5, wherein gear ratios of the first and second input gears are set to reduce the rotation speed of the motor torque of the auxiliary motor.

7. The auxiliary driving apparatus of claim 5, wherein gear ratios of the first and second idle gears are set to reduce the rotation speed of the motor torque input from the second input gear and transmit the motor torque to the differential ring gear.

8. The auxiliary driving apparatus of claim 1, wherein:
in a two-wheel drive (2WD) electric vehicle (EV) mode, the disconnector is disengaged and a power delivery path through which the motor torque of the auxiliary motor is transmitted to a front wheel drive shaft is blocked; and
in a 2WD series mode, the disconnector is disengaged and the clutch is operated so that a power delivery path through which the engine torque of the engine is transmitted to the auxiliary motor is connected.

9. The auxiliary driving apparatus of claim 1, wherein, in 4WD electric vehicle (EV) mode or an all-wheel drive (AWD) EV mode, the disconnector is operated and the clutch is released and a power delivery path that transmits the motor torque of the auxiliary motor to a front wheel drive shaft is connected.

10. An auxiliary driving apparatus for a four-wheel drive (4WD) hybrid electric vehicle that includes a first motor applied to a rear wheel side as a main driving source, the auxiliary driving apparatus comprising:
an auxiliary motor provided on a front wheel side of the hybrid electric vehicle, the auxiliary motor configured to output a motor torque;
an engine provided on the front wheel side of the hybrid electric vehicle, the engine configured to provide an engine torque to the auxiliary motor;
an auxiliary differential arranged between front wheel drive shafts on two sides of the hybrid electric vehicle, the auxiliary differential configured to absorb a difference in rotation speed of front wheels on the two sides and transmit the motor torque of the auxiliary motor to the front wheel drive shafts on the two sides of the electric hybrid vehicle;
an auxiliary reducer configured to
reduce a rotation speed of the motor torque input from the auxiliary motor through first and second idle gears on an idle shaft provided parallel between an engine output shaft of the engine and the auxiliary differential, and
output the motor torque to a differential ring gear of the auxiliary differential;
a disconnector disposed between the auxiliary differential and a front wheel among the front wheels of the electric hybrid vehicle, the disconnector configured to selectively transmit or block the motor torque of the auxiliary motor output through the auxiliary reducer to the front wheels on the two sides of the electric hybrid vehicle; and
a clutch provided on the engine output shaft of the engine, the clutch configured to selectively transmit or block the engine torque of the engine to the auxiliary motor through the auxiliary reducer, wherein the auxiliary reducer is configured to increase the engine torque of the engine and transmit the engine torque to the auxiliary motor.

11. The auxiliary driving apparatus of claim 10, wherein the disconnector comprises a dog clutch arranged between a pinion shaft of the auxiliary differential and a differential case.

12. The auxiliary driving apparatus of claim 10, wherein the disconnector comprises a dog clutch provided on a front wheel drive shaft among the front wheel drive shafts that transmit the motor torque from the auxiliary differential to the front wheels on the two sides of the electric hybrid vehicle.

13. The auxiliary driving apparatus of claim 10, wherein the clutch comprises a dog clutch or a wet-type clutch.

14. The auxiliary driving apparatus of claim 10, wherein the auxiliary reducer comprises:
a first input gear fixed to a motor shaft of the auxiliary motor;
a second input gear rotatably installed on the engine output shaft and selectively connected to the engine output shaft via the clutch;
an idle shaft arranged parallel between the engine output shaft and the auxiliary differential; and
first and second idle gears fixedly installed on a first side and a second side of the idle shaft and externally engaged with the second input gear and the differential ring gear of the auxiliary differential, respectively.

15. The auxiliary driving apparatus of claim 14, wherein gear ratios of the first and second input gears are set to reduce the rotation speed of the motor torque of the auxiliary motor.

16. The auxiliary driving apparatus of claim 14, wherein gear ratios of the first and second idle gears are set to reduce the rotation speed of the motor torque input from the second input gear and transmit the motor torque to the differential ring gear.

17. The auxiliary driving apparatus of claim 10, wherein:
in a two-wheel drive (2WD) electric vehicle (EV) mode, the disconnector is disengaged and a power delivery path through which the motor torque of the auxiliary motor is transmitted to a front wheel drive shaft is blocked; and
in 2WD series mode, the disconnector is disengaged and the clutch is operated so that the power delivery path through which the motor torque of the engine is transmitted to the auxiliary motor is connected.

18. The auxiliary driving apparatus of claim 10, wherein, in 4WD electric vehicle (EV) mode or an all-wheel drive (AWD) EV mode, the disconnector is operated and the clutch is released and a power delivery path that transmits the motor torque of the auxiliary motor to a front wheel drive shaft is connected.
